(19) United States
(12) Patent Application Publication
(10) Pub. No.: US 2024/0157964 A1
(43) Pub. Date: May 16, 2024

(54) PRESENTATION CONTROL DEVICE, AUTONOMOUS DRIVING CONTROL DEVICE, AND STORAGE MEDIUM THEREOF

(71) Applicant: DENSO CORPORATION, Kariya-city (JP)

(72) Inventors: Takuya KUME, Kariya-city (JP); Kazuki Izumi, Kariya-city (JP)

(21) Appl. No.: 18/408,753

(22) Filed: Jan. 10, 2024

Related U.S. Application Data
(63) Continuation of application No. PCT/JP2022/024688, filed on Jun. 21, 2022.

(30) Foreign Application Priority Data
Jul. 16, 2021 (JP) 2021-118053

(51) Int. Cl. B60W 60/00; B60W 40/04; B60W 50/00; B60W 50/14

(52) U.S. Cl. CPC B60W 60/001; B60W 40/04; B60W 50/0097; B60W 50/14; B60W 2556/40

(57) ABSTRACT

A presentation control device, which controls information presentation relating to autonomous driving function of a vehicle, is configured to: grasp whether a switch from a driving assist control, which requires a periphery monitoring by a driver as an obligation, to an autonomous traveling control, which does not require the periphery monitoring by the driver as the obligation, becomes possible; notify switch possible information when an interruption predicted section does not exist in a predetermined range defined in a traveling direction of the vehicle from a position where the switch to the autonomous traveling control becomes possible, the interruption predicted section being a section in which an interruption of the autonomous traveling control is predicted; and cancel a notification of the switch possible information when the interruption predicted section exists in the predetermined range.

### CROSS REFERENCE TO RELATED APPLICATIONS

The present application is a continuation application of International Patent Application No. PCT/JP2022/024688 filed on Jun. 21, 2022, which designated the U.S. and claims the benefit of priority from Japanese Patent Application No. 2021-118053 filed on Jul. 16, 2021. The entire disclosures of all of the above applications are incorporated herein by reference.

### TECHNICAL FIELD

The present disclosure relates to a control technique for presenting information related to an autonomous driving function and a technique for enabling traveling using the autonomous driving function.

### BACKGROUND

There has been known a vehicle system capable of performing autonomous driving of a host vehicle using a host vehicle position detected by a host vehicle position detection unit. The vehicle system predicts a road condition at a position in front of the host vehicle, and in response to determining that it is difficult to detect the host vehicle position due to, for example, a tunnel or the like and it is impossible to continue the autonomous driving, the vehicle system provides a previous notice of cancellation of the autonomous driving.

### SUMMARY

The present disclosure provides a presentation control device used in a vehicle capable of traveling with autonomous driving function. The presentation control device controls presentation of information relating to the autonomous driving function. The presentation control device is configured to: grasp whether a switch from a driving assist control, which requires a periphery monitoring by a driver as an obligation, to an autonomous traveling control, which does not require the periphery monitoring by the driver as the obligation, becomes possible; notify switch possible information when an interruption predicted section does not exist in a predetermined range defined in a traveling direction of the vehicle from a position where the switch to the autonomous traveling control becomes possible, the interruption predicted section being a section in which an interruption of the autonomous traveling control is predicted; and cancel a notification of the switch possible information when the interruption predicted section exists in the predetermined range.

### BRIEF DESCRIPTION OF DRAWINGS

Objects, features and advantages of the present disclosure will become apparent from the following detailed description made with reference to the accompanying drawings. In the drawings:

FIG. 1 is a diagram illustrating an overall view of an in-vehicle network including an HCU according to a first embodiment of the present disclosure;

FIG. 2 is a block diagram showing details of an autonomous driving ECU;

FIG. 3 is a block diagram showing details of an HCU;

FIG. 4 is a time chart showing an example of vehicle control and information presentation in a scene 1 in which an interruption predicted section exists in a forward range;

FIG. 5 is a flowchart showing details of driving control switching process executed by the autonomous driving ECU in the scene shown in FIG. 5;

FIG. 6 is a flowchart showing details of a notification control process executed by the HCU in the scene shown in FIG. 5;

FIG. 7 is a time chart showing an example of vehicle control and information presentation in a scene 2 in which an interruption predicted section exists in a forward range;

FIG. 8 is a flowchart showing details of a continuation determination process executed by the autonomous driving ECU in the scene shown in FIG. 7;

FIG. 9 is a flowchart showing details of a continuation determination process for determining whether an autonomous traveling control can be continued when a reliability of vehicle position information decreases; and

FIG. 10 is a flowchart showing details of a notification control process according to a second embodiment.

### DETAILED DESCRIPTION

In recent years, a technology that enables not only autonomous driving in which a driver is obligated to monitor periphery of vehicle but also autonomous driving in which the driver is not obligated to monitor periphery of vehicle has been provided. Even when the autonomous driving without periphery monitoring obligation is possible, the autonomous driving is highly likely to be interrupted when the reliability of host vehicle position information decreases due to, for example, a tunnel or the like. For this reason, there is a concern that convenience of autonomous driving without periphery monitoring obligation may be impaired in a predicted scene where the autonomous driving may be interrupted due to, such as decrease in reliability of the host vehicle position information.

According to an aspect of the present disclosure, a presentation control device is used in a vehicle capable of traveling with autonomous driving function. The presentation control device controls presentation of information relating to the autonomous driving function, and includes: a control grasping unit grasping whether a switch from a driving assist control, which requires a periphery monitoring by a driver as an obligation, to an autonomous traveling control, which does not require the periphery monitoring by the driver as the obligation, becomes possible; and a notification control unit notifying switch possible information indicating that the switch to the autonomous traveling control becomes possible. The notification control unit cancels a notification of the switch possible information when an interruption predicted section exists in a predetermined range defined in a traveling direction of the vehicle from a position where the switch to the autonomous traveling control becomes possible. The interruption predicted section is a section in which an interruption of the autonomous traveling control is predicted.

According to another aspect of the present disclosure, a presentation control device is used in a vehicle capable of traveling with autonomous driving function. The presentation control device controls presentation of information relating to the autonomous driving function, and includes: a control grasping unit grasping whether a switch from a driving assist control, which requires a periphery monitoring by a driver as an obligation, to an autonomous traveling control, which does not require the periphery monitoring by the driver as the obligation, becomes possible; and a notification control unit notifying switch possible information indicating that the switch to the autonomous traveling control becomes possible. The notification control unit notifies cancellation warning information, which indicates a warning of early cancellation of the autonomous traveling control, together with the switch possible information when an interruption predicted section exists in a predetermined range defined in a traveling direction of the vehicle from a position where the switch to the autonomous traveling control becomes possible. The interruption predicted section is a section in which an interruption of the autonomous traveling control is predicted.

According to another aspect of the present disclosure, a presentation control program is used in a vehicle capable of traveling with autonomous driving function. The presentation control program controls presentation of information relating to the autonomous driving function. The presentation control program includes instructions to be executed by at least one processor, and the instructions include: grasping whether a switch from a driving assist control, which requires a periphery monitoring by a driver as an obligation, to an autonomous traveling control, which does not require the periphery monitoring by the driver as the obligation, becomes possible; notifying switch possible information when an interruption predicted section does not exist in a predetermined range defined in a traveling direction of the vehicle from a position where the switch to the autonomous traveling control becomes possible, the interruption predicted section being a section in which an interruption of the autonomous traveling control is predicted; and cancelling a notification of the switch possible information when the interruption predicted section exists in the predetermined range.

According to another aspect of the present disclosure, a presentation control program is used in a vehicle capable of traveling with autonomous driving function. The presentation control program controls presentation of information relating to the autonomous driving function. The presentation control program includes instructions to be executed by at least one processor, and the instructions include: grasping whether a switch from a driving assist control, which requires a periphery monitoring by a driver as an obligation, to an autonomous traveling control, which does not require the periphery monitoring by the driver as the obligation, becomes possible; notifying switch possible information when an interruption predicted section does not exist in a predetermined range defined in a traveling direction of the vehicle from a position where the switch to the autonomous traveling control becomes possible, the interruption predicted section being a section in which an interruption of the autonomous traveling control is predicted; and notifying cancellation warning information, which indicates a warning of early cancellation of the autonomous traveling control, together with the switch possible information when the interruption predicted section exists in the predetermined range.

In the above configurations, when the interruption predicted section in which the interruption of autonomous traveling control is predicted exists in the traveling direction of the host vehicle, the notification of switch possible information is not performed, or the cancellation warning information for warning the early cancellation of autonomous traveling control is notified together with the switch possible information. With this configuration, the switch to the autonomous traveling control is suppressed when the interruption is predicted. Also, a scene in which the autonomous traveling control ends within a short period is less likely to occur. Thus, it is possible to ensure the convenience of autonomous driving without periphery monitoring obligation.

According to another aspect of the present disclosure, an autonomous driving control device, which enables a vehicle to travel by an autonomous driving function, includes: a traveling control unit executing an autonomous traveling control, which does not require a periphery monitoring by a driver as an obligation, to the vehicle using position information of the vehicle, the position information of the vehicle being specified based on positioning signals transmitted from multiple positioning satellites; a section grasping unit grasping existence of an interruption predicted section in which an interruption of the autonomous traveling control is predicted due to a decrease in reliability of the position information of the vehicle associated with a deteriorated reception state of the positioning signals; and a congestion grasping unit grasping a situation of traffic congestion being occurred in a traveling direction of the vehicle. When the interruption predicted section has a traffic congestion, the traveling control unit permits continuation of the autonomous traveling control even though the reliability of the position information of the vehicle decreases.

According to another aspect of the present disclosure, an autonomous driving control program, which enables a vehicle to travel by an autonomous driving function, includes instructions to be executed by at least one processor. The instructions include: executing an autonomous traveling control, which does not require a periphery monitoring by a driver as an obligation, to the vehicle using position information of the vehicle, the position information of the vehicle being specified based on positioning signals transmitted from multiple positioning satellites; grasping existence of an interruption predicted section in which an interruption of the autonomous traveling control is predicted due to a decrease in reliability of the position information of the vehicle associated with a deteriorated reception state of the positioning signals; grasping a situation of traffic congestion being occurred in a traveling direction of the vehicle; and when the interruption predicted section has a traffic congestion, permitting continuation of the autonomous traveling control even though the reliability of the position information of the vehicle decreases.

In the above configurations, when the interruption predicted section, in which the interruption of autonomous traveling control is predicted due to decrease in the reliability of host vehicle position information, is recognized and a traffic congestion is recognized in the interruption predicted section, the continuation of autonomous traveling control is permitted even though the reliability of host vehicle position information decreases. When traveling in a traffic congestion, the traveling speed of host vehicle decreases, and information on other vehicles existing around the host vehicle can be used. Therefore, the autonomous traveling control can be continued without depending on the host vehicle position information. Therefore, even in a case where the reliability of host vehicle position information decreases, by permitting continuation of autonomous traveling control on the condition that the host vehicle travels in a traffic congestion, it is possible to ensure the convenience of autonomous driving without periphery monitoring obligation.

According to another aspect of the present disclosure, an autonomous driving control device, which enables a vehicle to travel by an autonomous driving function, includes: a position information acquiring unit acquiring position information of the vehicle based on positioning signals transmitted from multiple positioning satellites; a traveling control unit executing an autonomous traveling control, which does not require a periphery monitoring by a driver as an obligation, to the vehicle using the position information of the vehicle. The traveling control unit switches a control mode of the autonomous traveling control within multiple control modes. The multiple control modes at least include a congestion limited control, which permits the autonomous traveling control only in a traffic congestion, and an area limited control, which permits the autonomous traveling control only in a specific area. When the vehicle travels under the congestion limited control, the traveling control unit sets the autonomous traveling control to be less likely interrupted due to a decrease in reliability of the position information of the vehicle associated with a deteriorated reception state of the positioning signals, compared with when the vehicle travels under the area limited control.

According to another aspect of the present disclosure, an autonomous driving control program, which enables a vehicle to travel by an autonomous driving function, includes instructions to be executed by at least one processor. The instructions include: executing an autonomous traveling control, which does not require a periphery monitoring by a driver as an obligation, to the vehicle using position information of the vehicle, the position information of the vehicle being specified based on positioning signals transmitted from multiple positioning satellites; switching a control mode of the autonomous traveling control within multiple control modes, the multiple control modes at least including a congestion limited control, which permits the autonomous traveling control only in a traffic congestion, and an area limited control, which permits the autonomous traveling control only in a specific area; and when the vehicle travels under the congestion limited control, setting the autonomous traveling control to be less likely interrupted due to a decrease in reliability of the position information of the vehicle associated with a deteriorated reception state of the positioning signals, compared with when the vehicle travels under the area limited control.

In the above configurations, when the vehicle travels under the congestion limited control, the autonomous driving control is set to be less likely interrupted due to a decrease in reliability of the position information of the vehicle associated with a deteriorated reception state of the positioning signals compared with when the host vehicle travels under the area limited control. When traveling in a traffic congestion, the traveling speed of host vehicle decreases, and information on other vehicles existing around the host vehicle can be used. Therefore, the autonomous traveling control can be continued without depending on the host vehicle position information. Therefore, even in a case where the reliability of host vehicle position information decreases, by continuing the traveling under congestion limited control, it is possible to ensure the convenience of autonomous driving without periphery monitoring obligation.

The following will describe embodiments of the present disclosure with reference to accompanying drawings. In the following description, the same reference symbols are assigned to corresponding components in each embodiment in order to avoid repetitive descriptions. In each of the embodiments, when only a part of the configuration is described, the remaining parts of the configuration may adopt corresponding parts of other embodiments. Further, not only the combinations of the configurations explicitly shown in the description of the respective embodiments, but also the configurations of the multiple embodiments can be partially combined even if they are not explicitly shown if there is no problem in the combinations in particular.

### First Embodiment

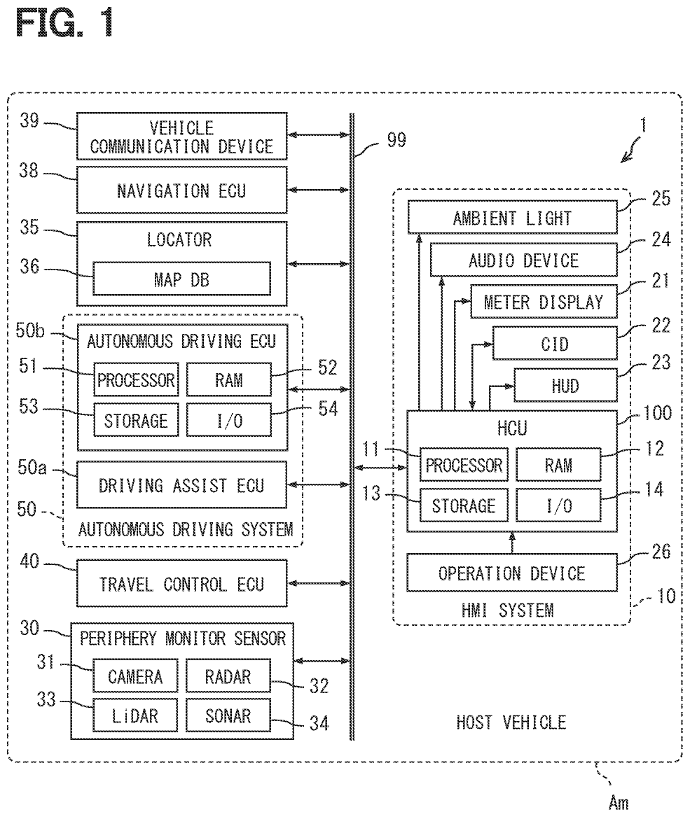

According to a first embodiment of the present disclosure, a human machine interface control unit (HCU) illustrated in FIG. 1 to FIG. 3 is an interface control device used in a vehicle. The vehicle equipped with the HCU is also referred to as a host vehicle Am. The HCU 100 configures a human machine interface (HMI) system 10 of the host vehicle Am together with multiple input/output devices and the like. The HMI system 10 has an input interface function of receiving an operation made by an occupant, such as a driver of the host vehicle Am. The HMI system 10 has an output interface function of presenting information to the occupant, such as the driver.

The HCU 100 is communicably connected to a communication bus 99 of an in-vehicle network 1 equipped to the host vehicle Am. The HCU 100 is one of multiple nodes provided in the in-vehicle network 1. A periphery monitoring sensor 30, a locator 35, a navigation electronic control unit (ECU) 38, a vehicle communication device 39, and the like are connected to a communication bus 99 of the in-vehicle network 1. A traveling control ECU 40, a driving assist ECU 50a, an autonomous driving ECU 50b, and the like are connected to the communication bus 99. The nodes connected to the communication bus 99 can communicate with one another. Specific nodes among these devices, ECUs, and the like may be directly electrically connected to one another and may communicate with one another without using the communication bus 99.

The periphery monitoring sensor 30 is an autonomous sensor that monitors the periphery environment of the host vehicle Am. The periphery monitoring sensor 30 includes, for example, at least one of a camera unit 31, a millimeter wave radar 32, a lidar 33, or a sonar 34. The periphery monitoring sensor 30 can detect a moving object or a stationary object from a detection range around the host vehicle. The periphery monitoring sensor 30 provides detection information of an object around the host vehicle to the driving assist ECU 50a, the autonomous driving ECU 50b, or the like.

The locator 35 includes a global navigation satellite system (GNSS) receiver, an inertial sensor, and the like. The locator 35 combines positioning signals received by the GNSS receiver from multiple positioning satellites, measurement result of an inertial sensor, vehicle speed information output to the communication bus 99, and the like, and successively specifies a position and a travelling direction of the host vehicle Am. The locator 35 further includes a map database 36 that stores three-dimensional map data and two-dimensional map data. The locator 35 reads map data around the current position from the map database 36, and provides the map data as locator information to the driving assist ECU 50a, the autonomous driving ECU 50b, and the like together with own position information and the direction information of the host vehicle Am.

The navigation ECU 38 acquires position information and direction information of the host vehicle Am from the locator 35, and sets a route from the current position to a destination set by the driver or the like. The navigation ECU 38 route information, which indicates the set route to the destination, to the driving assist ECU 50a, the autonomous driving ECU 50b, the HCU 100, and the like. The navigation ECU 38 cooperates with the HMI system 10 to notify the driver of the traveling direction of the host vehicle Am at an intersection, a branch point, and the like by combining a screen display, an audio message, and the like as route guidance to the destination.

A user terminal, such as a smartphone may be connected to the in-vehicle network 1 or the HCU 100. Instead of the locator 35, the user terminal may provide host vehicle position information, the direction information, the map data, and the like to the driving assist ECU 50a and the autonomous driving ECU 50b. Instead of the navigation ECU 38, the user terminal may provide the route information to the destination to the HCU 100.

The vehicle communication device 39 is a communication unit mounted on the host vehicle Am, and functions as a vehicle to everything (V2X) communication device. The vehicle communication device 39 transmits and receives information by wireless communication to and from a roadside device installed along the roadside. As an example, the vehicle communication device 39 receives, from the roadside device, traffic congestion information, road construction information, and the like around the current position and in the traveling direction of the host vehicle Am. The traffic congestion information and the road construction information may be VICS (registered trademark) information or the like. The vehicle communication device 39 provides the received traffic congestion information and road construction information to the autonomous driving ECU 50b and the like.

The traveling control ECU 40 is an electronic control unit mainly including a microcontroller. The traveling control ECU 40 has functions of a brake control ECU, a drive control ECU, and a steering control ECU. The traveling control ECU 40 may have other functions in addition to these functions. The traveling control ECU 40 continuously performs a braking force control for each wheel, an output control of vehicle-mounted traveling power source, and a steering angle control based on one of (i) an operation command based on driving operation of the driver, (ii) a control command of the driving assist ECU 50a, or (iii) a control command of the autonomous driving ECU 50b.

The driving assist ECU 50a and the autonomous driving ECU 50b constitute an autonomous driving system 50 of the host vehicle Am. By mounting the autonomous driving system 50, the host vehicle Am corresponds to an autonomous driving vehicle having an autonomous driving function and can travel by the autonomous driving function.

The driving assist ECU 50a implements a driving assist function for assisting the driving operation of the driver in the autonomous driving system 50. The driving assist ECU 50a enables advanced driving assistance or partial autonomous driving at about level 2 according to autonomous driving levels defined by the Society of Automotive Engineers of the United States. The autonomous driving performed by the driving assist ECU 50a is autonomous driving with periphery monitoring obligation, which requires monitoring of periphery of the host vehicle by visual observation of the driver.

The autonomous driving ECU 50b can substitute for the driving operation of the driver, and can perform autonomous driving of level 3 or higher in which the system is a control subject. The autonomous driving level refers to the level defined by the Society of Automotive Engineers of the United States. The autonomous driving performed by the autonomous driving ECU 50b does not require periphery monitoring of the host vehicle, that is, eyes-off autonomous driving without periphery monitoring obligation.

In the autonomous driving system 50 described above, the traveling control state of autonomous driving function can be switched among multiple traveling control states including at least the autonomous traveling control with periphery monitoring obligation executed by the driving assist ECU 50a and the autonomous traveling control without periphery monitoring obligation executed by the autonomous driving ECU 50b. In the following description, the autonomous driving control of level 2 or lower executed by the driving assist ECU 50a is referred to as driving assist control, and the autonomous driving control of level 3 or higher executed by the autonomous driving ECU 50b is referred to as autonomous traveling control.

In the autonomous driving period during which the host vehicle Am travels by the autonomous traveling control, the driver may be permitted to perform a specific action defined in advance (hereinafter referred to as a second task) other than driving operation. The second task is legally permitted to the driver until a request for performing driving operation by the autonomous driving ECU 50b and the HCU 100 in cooperation with one another, that is, a request for driving change occurs. For example, viewing of entertainment content such as video content, operation of a device such as a smartphone, or an action such as eating is assumed as the second task.

The driving assist ECU 50a is provided by a computer, which mainly includes a control circuit. The control circuit includes a processor, a RAM, a storage, an input/output interface, and a bus connecting these components. The driving assist ECU 50a implements driving assist functions of adaptive cruise control (ACC), lane trace control (LTC), and the like by executing programs by the processing unit. The driving assist ECU 50a performs the driving assist control for controlling the host vehicle Am to keep traveling along the currently traveling lane of host vehicle Am, by cooperation of functions of ACC and LTC. The driving assist ECU 50a provides control status information indicating a status of driving assist control to the autonomous driving ECU 50b.

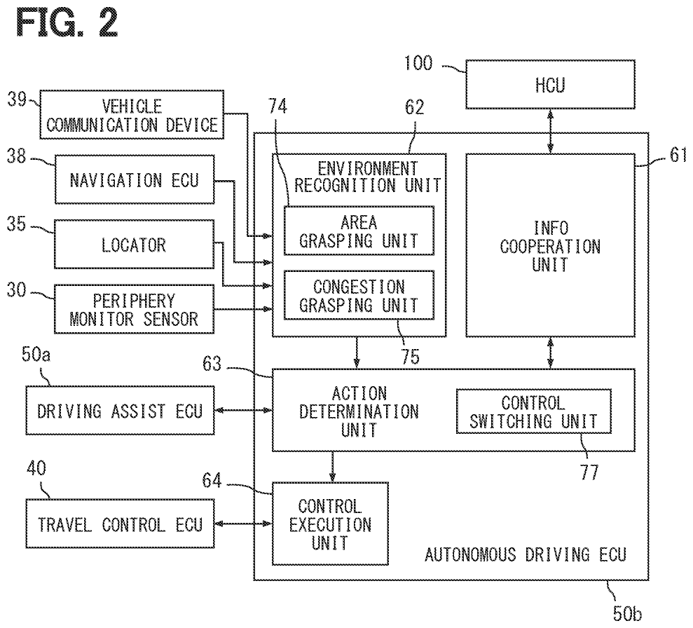

The autonomous driving ECU 50b has a higher calculation capability than the driving assist ECU 50a, and can perform at least traveling control corresponding to ACC and LTC. The autonomous driving ECU 50b is provided by a computer, which mainly includes a control circuit. The control circuit includes a processor 51, a RAM 52, a storage 53, an input/output interface 54, and a bus connecting these components. The processor 51 executes various processes for implementing the autonomous driving control method of the present disclosure by accessing the RAM 52. The storage 53 stores various programs (such as an autonomous driving control program) to be executed by the processor 51. The autonomous driving ECU 50b includes, as functional units, an information cooperation unit 61, an environment recognition unit 62, an action determination unit 63, a control execution unit 64, and the like for implementing the autonomous driving function (see FIG. 2). These function units are implemented by execution of the program stored in the storage by the processor 51.

The information cooperation unit 61 provides information to an information cooperation unit 82 of the HCU 100, and acquires information from the information cooperation unit 82 of the HCU 100. The autonomous driving ECU 50b and the HCU 100 share information acquired by the autonomous driving ECU 50b and the HCU 100 through cooperation of respective information cooperation units 61 and 82. The information cooperation unit 61 generates control status information indicating the operation state of autonomous driving function, and provides the generated control status information to the information cooperation unit 82. The information cooperation unit 61 enables the HCU 100 to perform notification in synchronization with the operation state of autonomous driving function by outputting an execution request of notification to the information cooperation unit 82. The information cooperation unit 61 acquires the operation information of the drive from the information cooperation unit 82. The information cooperation unit 61 can grasp the driver operation input to the HMI system 10 or the like based on the operation information of driver.

The environment recognition unit 62 recognizes a traveling environment of host vehicle Am by combining locator information acquired by the locator 35 and detection information acquired by the periphery monitoring sensor 30. The environment recognition unit 62 grasps information on a traveling road of the host vehicle Am, a relative position and a relative speed of a moving target (another vehicle or the like) existing around the host vehicle, and the like. The environment recognition unit 62 acquires vehicle information indicating the state of host vehicle Am from the communication bus 99. As an example, the environment recognition unit 62 acquires vehicle speed information indicating the current traveling speed of host vehicle Am. The environment recognition unit 62 includes an area grasping unit 74 and a congestion grasping unit 75 as sub-functional units for recognizing the traveling environment.

The area grasping unit 74 determines whether the currently traveling road of the host vehicle Am or a scheduled traveling road of the host vehicle Am is an autonomous driving available area (hereinafter, referred to as an AD area) or a limited AD area. The AD area and the limited AD area are defined in advance. The information indicating whether the area is the AD area or the limited AD area may be recorded in the map data, which is stored in the map database 36, or may be included in the information received by the vehicle communication device 39.

The AD area and the limited AD area may correspond to an operational design domain in which autonomous driving without periphery monitoring obligation of the driver is legally permitted. The autonomous driving without periphery monitoring obligation includes, as multiple control modes, a congestion limited control (hereinafter, referred to as a congestion state level 3) performed only for traveling in congestion state and an area limited control (hereinafter, referred to as an area level 3) performed only in the AD area. On the road within the AD area, execution of both the congestion state level 3 and the area level 3 are permitted. On the road within the limited AD area, execution of only the congestion state level 3 is permitted. In a manual driving area (hereinafter, referred to as an MD area) that is not included in any of the AD area and the limited AD area, traveling with the autonomous traveling control of level 3 is prohibited in principle. In the MD area, traveling with autonomous driving of level 2 or higher may be prohibited. The AD area or the limited AD area may be set on, for example, an expressway, a motorway, or the like.

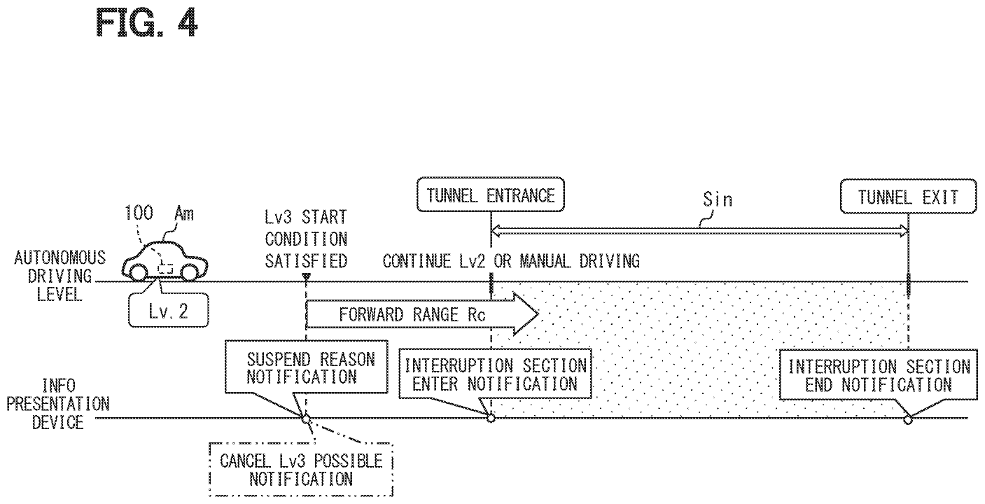

The area grasping unit 74 grasps the existence of an interruption predicted section Sin (see FIG. 4) in which the autonomous traveling control is predicted to be interrupted. The interruption predicted section Sin is, in principle, a section of the road within the AD area or the limited AD area. The interruption predicted section Sin includes a road section in which the autonomous traveling control is not legally permitted, a road section in which continuation of the autonomous traveling control becomes difficult due to a traveling environment, a road section in which continuation of the autonomous traveling control becomes difficult due to a system factor, and the like. The interruption predicted section Sin in which the autonomous traveling control is not legally permitted may include sections before and after a merging point, sections before and after a tollgate, and the like. The interruption predicted section Sin in which the autonomous traveling control is not legally permitted is set within the AD area or the limited AD area. The interruption predicted section Sin in which continuation of the autonomous traveling control becomes difficult due to a traveling environment includes a tunnel section in which the reception sensitivity of the positioning signal decreases, a road section within a mountain area, a road section surrounded by high-rise buildings, and a road construction section in which road construction is being performed. The interruption predicted section Sin in which continuation of the autonomous traveling control becomes difficult due to a system factor includes a road section for which high-precision map data necessary for the autonomous traveling control is not prepared. The construction section may be treated as a road section for which the high-precision map data is not prepared.

The area grasping unit 74, by referring to the locator information, acquires the position information and the direction information of the host vehicle based on the positioning signal of the host vehicle, and acquires the map data in the traveling direction of the host vehicle Am. The area grasping unit 74, by referring to the map data, estimates the existence of interruption predicted section Sin in the traveling direction of the host vehicle Am based on the type information of the road, the building information and the topographical information around the road, and the like recorded in the map data. In a case where information indicating the interruption predicted section Sin is attached to the map data in advance, the area grasping unit 74 may recognize the existence of interruption predicted section Sin based on the attached information of map data. The area grasping unit 74 may recognize the existence of interruption predicted section Sin based on the road construction information received by the vehicle communication device 39.

When the destination is set in the navigation ECU 38, the area grasping unit 74 uses the route information acquired from the navigation ECU 38 to determine existence of the interruption predicted section Sin. Based on the route information, the area grasping unit 74 specifies a scheduled traveling road of the host vehicle Am from multiple roads existing in the traveling direction. As an example, suppose that a branch exists in the traveling direction of the host vehicle, a tunnel exists when the vehicle travels in one side (for example, the right side) of the branch and no tunnel exists when the vehicle travels to the other side (for example, the left side) of the branch. In such a scene, when there is no route information, the area grasping unit 74 determines existence of the interruption predicted section Sin before the host vehicle reaches the branch regardless of the direction in which the host vehicle Am actually travels at the branch. In a case where there is route information indicating that the vehicle travels to the left side of the branch, the area grasping unit 74 determines that there is no interruption predicted section Sin in the traveling direction before the host vehicle reaches the branch even if the area grasping unit 74 grasps the existence of a tunnel in the right side of the branch.

The congestion grasping unit 75 grasps a situation of congestion occurred around the host vehicle Am and in the traveling direction of the host vehicle Am by combining the detection information of other vehicles around the host vehicle, the vehicle speed information, and the like. When a current traveling speed of host vehicle Am is equal to or lower than a congestion speed (for example, about 30 km/h) and both a preceding vehicle and a following vehicle travel in the current traveling lane of host vehicle, the congestion grasping unit 75 determines that the periphery environment of the host vehicle is the congestion state. The congestion grasping unit 75 can grasp the congestion situation around the host vehicle and in the traveling direction based on the congestion information received by the vehicle communication device 39.

The action determination unit 63 cooperates with the driving assist ECU 50a and the HCU 100 to control a change of driving operation between the autonomous driving system 50 and the driver. When the autonomous driving system 50 has a control right of the driving operation, the action determination unit 63 controls the host vehicle Am to travel in a state without periphery monitoring obligation of the driver by the autonomous traveling control based on the host vehicle position information, the detection information, and the like. Specifically, the action determination unit 63 generates a planned traveling line along which the host vehicle Am travels based on the recognition result of the traveling environment recognized by the environment recognition unit 62, and outputs the generated planned traveling line to the control execution unit 64. The action determination unit 63 includes a control switching unit 77 as a sub-functional unit for controlling an operation state of the autonomous driving function.

The control switching unit 77, by cooperating with the driving assist ECU 50a, switches the control state between the driving assist control with periphery monitoring obligation of the driver and the autonomous traveling control with no periphery monitoring obligation of the driver. Specifically, the control switching unit 77 determines whether a switch condition (hereinafter, referred to as a level 3 start condition) for permitting the switch to the autonomous traveling control is satisfied. The level 3 start condition includes a requirement regarding the driver of the host vehicle Am, a requirement regarding the traveling state of the host vehicle Am, a requirement regarding the traveling environment around the host vehicle, and the like. The control switching unit 77 permits the switch to the autonomous traveling control based on the satisfaction of the level 3 start condition. When the host vehicle Am is traveling by the autonomous traveling control, the control switching unit 77 switches the control mode of the autonomous traveling control among multiple control modes including the congestion state level 3 and the area level 3.

When the autonomous driving ECU 50b has the control right of driving operation, the control execution unit 64 executes, in cooperation with the traveling control ECU 40, acceleration/deceleration control, steering control, and the like of the host vehicle Am according to the planned traveling line generated by the action determination unit 63. The control execution unit 64 generates a control command based on the planned traveling line and sequentially outputs the generated control command to the traveling control ECU 40.

The following will describe, in order, details of the multiple display devices, an audio device 24, an ambient light 25, an operation device 26, and the HCU 100 included in the HMI system 10.

The display devices present information to the driver's visual sensation by display of image or the like. The display devices include a meter display 21, a center information display (hereinafter referred to as CID) 22, a head-up display (hereinafter referred to as HUD) 23, and the like. The CID 22 has a function of touch panel, and detects a touch operation made by a driver on a display screen.

The audio device 24 has multiple speakers installed in the vehicle compartment around the driver's seat, and controls the speakers to reproduce a notification sound, a voice message, or the like in the vehicle compartment. The ambient light 25 is provided on an instrument panel, a steering wheel, or the like. The ambient light 25 performs information presentation using a peripheral visual field of the driver by ambient display in which an emission color of the light is changed.

The operation device 26 is an input unit that receives an operation of user, such as a driver or the like. For example, the operation device 26 receives a user operation related to activation and deactivation of autonomous driving function. As another example, the operation device 26 receives a level 2 switch operation for instructing the start of driving assist control, a level 3 switch operation for instructing the switch from driving assist control to autonomous traveling control. The operation device 26 includes a steering switch located on a spoke portion of a steering wheel, an operation lever located on a steering column portion, a voice input device that recognizes a content of driver's voice, and the like.

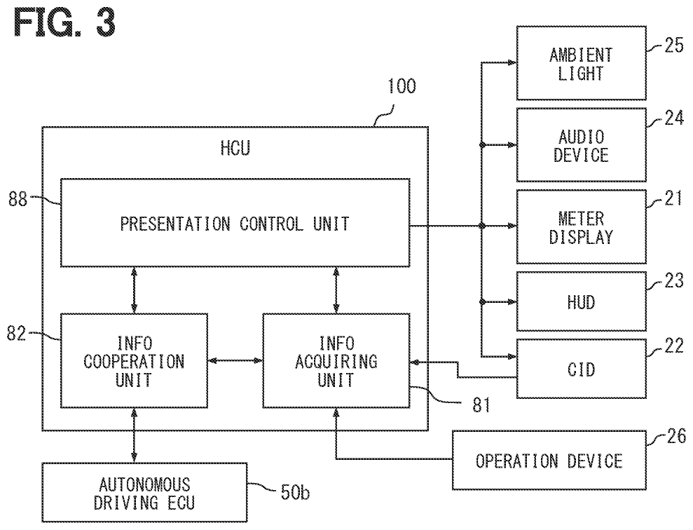

The HCU 100 is an information presentation device that integrally controls information presentation using the multiple display devices, the audio device 24, and the ambient light 25. The HCU 100 controls presentation of information related to autonomous driving in cooperation with the autonomous driving system 50. The HCU 100 is provided by a computer, which mainly includes a control circuit. The control circuit includes a processor 11, a RAM 12, a storage 13, an input/output interface 14, and a bus connecting these components. The processor 11 executes a presentation control process by accessing to the RAM 12. The RAM 12 may include a video RAM for generating video data. The storage 13 includes a non-volatile storage medium. The storage 13 stores various programs (such as a presentation control program) to be executed by the processor 11. The HCU 100 constructs multiple functional units by controlling the processor 11 to execute programs stored in the storage 13. The HCU 100 includes, as functional units, an information acquiring unit 81, an information cooperation unit 82, and a presentation control unit 88 (see FIG. 3).

The information acquiring unit 81 acquires vehicle information (for example, vehicle speed information) indicating the state of host vehicle Am from the communication bus 99. The information acquiring unit 81 acquires operation information indicating the content of user operation from the CID 22, the operation device 26, and the like.

The information cooperation unit 82 cooperates with the autonomous driving ECU 50b to enable sharing of information between the autonomous driving system 50 and the HCU 100. The information cooperation unit 82 provides operation information grasped by the information acquiring unit 81 to the autonomous driving ECU 50b. The information cooperation unit 82 acquires, from the autonomous driving ECU 50b, an execution request for information presentation related to the autonomous driving function and control status information indicating the status of autonomous driving function.

The information cooperation unit 82 grasps the operation state of autonomous driving executed by the autonomous driving system 50 based on the control status information. The information cooperation unit 82 grasps whether the traveling control being executed is the driving assist control or the autonomous traveling control, that is, whether the autonomous driving control without periphery monitoring obligation of driver is being executed by the autonomous driving function.

When the autonomous driving system 50 controls the host vehicle Am to travel by the driving assist control, the information cooperation unit 82 grasps whether the switch from the driving assist control to the autonomous traveling control becomes possible based on the control status information. For example, when the level 3 start condition is determined to be satisfied by the control switching unit 77, the information cooperation unit 82 determines that the switch to the autonomous traveling control becomes possible. When the information cooperation unit 82 grasps that the switch to the autonomous traveling control becomes possible, the information cooperation unit 82 further grasps whether the interruption predicted section Sin in the traveling direction is recognized by the autonomous driving ECU 50b. When the autonomous driving system 50 controls the host vehicle Am to travel by the autonomous traveling control, the information cooperation unit 82 further specifies the control mode of autonomous traveling control.

The presentation control unit 88 integrally provides information to the driver using each display device, the audio device 24, and the ambient light 25 (hereinafter, referred to as an information presentation device). The presentation control unit 88 provides contents and presents information in accordance with an operation state of the autonomous driving based on the control status information and execution request acquired by the information cooperation unit 82. The presentation control unit 88 enables playback of video content or the like when execution of autonomous traveling control in the eyes-off state is grasped by the information cooperation unit 82. The presentation control unit 88 outputs a request for driving change or the like to the driver based on the execution request acquired by the information cooperation unit 82.

The presentation control unit 88 presents a notification of switch possible information (hereinafter, referred to as a level 3 possible notification) indicating that the switch to autonomous traveling control is possible, and presents a notification of switch start information (hereinafter, referred to as a level 3 start notification) indicating that the autonomous traveling control is to be started. The presentation control unit 88 performs the level 3 possible notification when the information cooperation unit 82 grasps that the level 3 start condition is satisfied. The presentation control unit 88 controls the meter display 21, the CID 22, and the like to display, for example, a message such as “Second task becomes available.” as the level 3 possible notification. The presentation control unit 88 performs the level 3 start notification in accordance with the control switch to the autonomous traveling control. As the level 3 start notification, the presentation control unit 88 controls each display device to display, for example, a message such as “Please pay attention to information from the vehicle. Autonomous driving will be canceled due to periphery road conditions.”

When the interruption predicted section Sin exists in the traveling direction of the host vehicle, the autonomous driving system 50 and the HCU 100 described above perform vehicle control and information presentation under an assumption that the host vehicle Am enters the interruption predicted section Sin. Hereinafter, details of vehicle control and information presentation in two different scenes where the host vehicle Am enters the interruption predicted section Sin will be described in order based on FIG. 4 to FIG. 8, by referring to FIG. 1 to FIG. 3 as necessary.

(1. A scene in which the host vehicle traveling by the driving assist control approaches the interruption predicted section)

In the scene illustrated in FIG. 4, the control switch from the driving assist control to the autonomous traveling control is temporarily stopped due to the existence of interruption predicted section Sin (see the dotted range) in a forward range Rc of the host vehicle Am. The autonomous driving system 50 suspends the switch to the autonomous traveling control at least until the host vehicle Am passes through the interruption predicted section Sin. In the interruption predicted section Sin, the autonomous driving system 50 continues traveling by the hands-on driving assist control or switches to manual driving by ending the driving assist control.

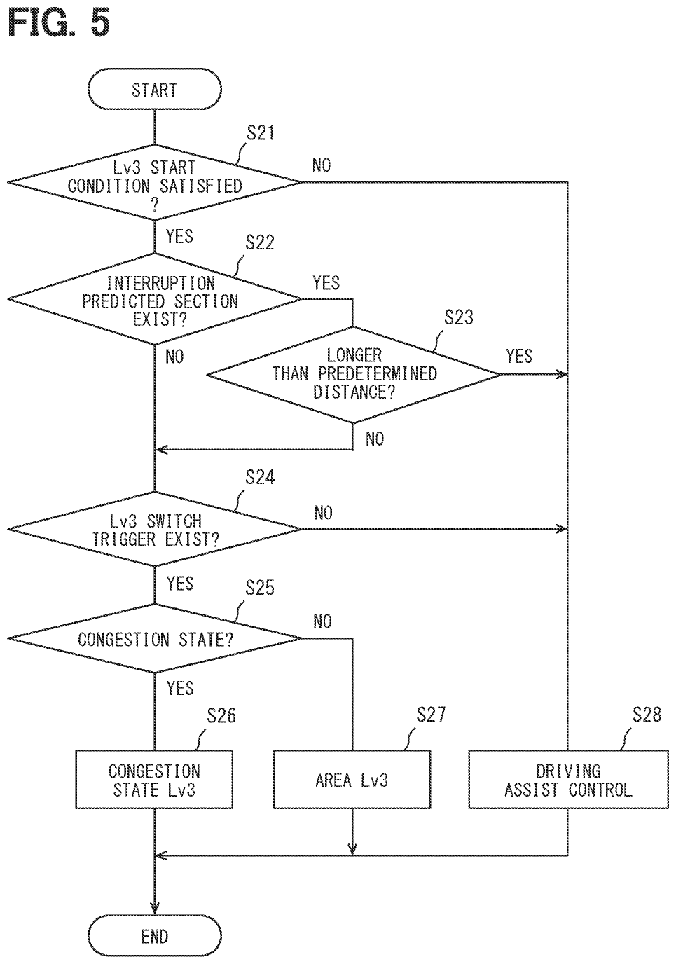

The control switching unit 77 executes a driving control switching process (see FIG. 5), which includes suspending of the control switch to the autonomous traveling control. The control switching unit 77 starts the driving control switching process in response to start of the driving assist control by the autonomous driving system 50. The control switching unit 77 repeatedly performs the driving control switching process until the switch to the autonomous traveling control is completed or until the driving is switched to the manual driving by cancelling the autonomous driving function.

The control switching unit 77 determines whether the level 3 start condition is satisfied (S21). When the level 3 start condition is not satisfied (S21: NO), the control switching unit 77 continues the driving assist control by the driving assist ECU 50a (S28). When partial or all of the level 3 start conditions are satisfied (S21: YES), the control switching unit 77 determines existence of interruption predicted section Sin (S22). The control switching unit 77 determines the existence of interruption predicted section Sin within a predetermined range (hereinafter referred to as a forward range Rc) defined in the traveling direction from the point where the switch to the autonomous traveling control becomes possible, in other words, the point where the level 3 start condition is satisfied. The forward range Rc is, for example, a range of about 2 km in forward direction of the host vehicle Am.

When at least a part of the interruption predicted section Sin is included in the forward range Rc (S22: YES), the control switching unit 77 grasps whether a length of the interruption predicted section Sin exceeds a predetermined distance (S23). The predetermined distance is a distance at which the autonomous traveling control can be continued even if the reliability of host vehicle position information temporarily decreases. For example, the predetermined distance may be set to about several tens to several hundreds of meters. When the length of interruption predicted section Sin exceeds the predetermined distance (S23: YES), the control switching unit 77 suspends the control switch to the autonomous traveling control and continues the driving assist control even though the level 3 start condition is satisfied (S28).

When the interruption predicted section Sin does not exist in the forward range Rc (S22: NO), or when the length of interruption predicted section Sin is equal to or shorter than the predetermined distance (S23: NO), the control switching unit 77 determines existence of a switch trigger to the autonomous traveling control (S24). The switch trigger to the autonomous traveling control (hereinafter, referred to as a level 3 switch trigger) is, for example, a level 3 switch operation input by the driver, an automatic switch determination by the system based on satisfaction of a condition different from the level 3 start condition, or the like. When no level 3 switch trigger exists (S24: NO), the driving assist ECU 50a continues the driving assist control (S28).

When the level 3 switch trigger exists (S24: YES), the control switching unit 77 starts the traveling of the host vehicle Am by the autonomous traveling control. In this case, the control switching unit 77 switches the control mode of the autonomous traveling control among multiple control modes, which include the congestion state level 3 and the area level 3 (S25 to S27). Specifically, when a traffic congestion around the host vehicle is recognized (S25: YES), the control switching unit 77 controls the host vehicle Am to travel at the congestion state level 3 (S26). When a traffic congestion is not recognized around the host vehicle (S25: NO), the control switching unit 77 controls the host vehicle Am to travel at the area level 3 (S27).

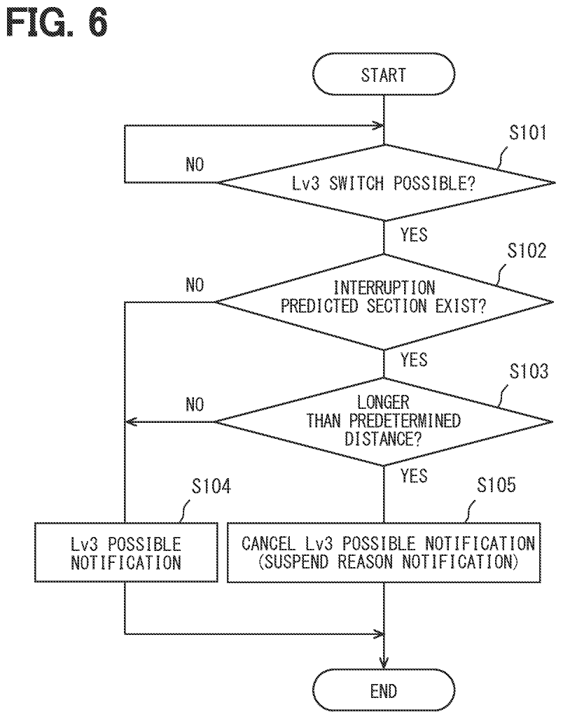

The HCU 100 performs a notification control process (see FIG. 6) in order to perform or cancel the level 3 possible notification according to the existence of the interruption predicted section Sin. Based on the control status information acquired from the autonomous driving ECU 50b, the information cooperation unit 82 grasps whether the switch from the driving assist control to the autonomous traveling control becomes possible (S101). In response to determining that the switch to the autonomous traveling control becomes possible (S101: YES), the information cooperation unit 82 grasps whether the interruption predicted section Sin existing in the forward range Rc is recognized by the autonomous driving ECU 50b (S102). When the interruption predicted section Sin is recognized by the autonomous driving ECU 50b (S102: YES), the information cooperation unit 82 determines whether the length of recognized interruption predicted section Sin exceeds the predetermined distance (S103).

When the interruption predicted section Sin does not exist in the forward range Rc (S102: NO) or when the length of interruption predicted section Sin existing in the forward range Rc is equal to or less than the predetermined distance (S103: NO), the presentation control unit 88 performs the level 3 possible notification (S104).

When the length of interruption predicted section Sin, which exists in the forward range Rc, exceeds the predetermined distance (S103: YES), the presentation control unit 88 cancels, that is, does not perform the level 3 possible notification in accordance with the suspending of the control switch to the autonomous traveling control (S105). In a case where the level 3 possible notification is cancelled, the presentation control unit 88 performs notification of suspending reason information (hereinafter, referred to as a suspending reason notification) indicating a reason why the switch to the autonomous traveling control is suspended. The presentation control unit 88 controls the meter display 21 or the like to display a message such as “A tunnel exists ahead. Autonomous driving cannot be used.” as the suspending reason notification.

The presentation control unit 88 performs an interruption section entry notification (see FIG. 4) in response to the host vehicle Am entering the interruption predicted section Sin. The presentation control unit 88 controls the meter display 21 or the like to display, for example, a message such as “Autonomous driving cannot be used in a tunnel.” as the interruption section entry notification. The presentation control unit 88 performs an interruption section end notification (see FIG. 4) in response to the host vehicle Am exiting from the interruption predicted section Sin. The presentation control unit 88 controls the meter display 21 or the like to display, for example, a message such as “Autonomous driving is available.” as the interruption section end notification.

(2. A scene in which the host vehicle traveling by the autonomous traveling control approaches the interruption predicted section)

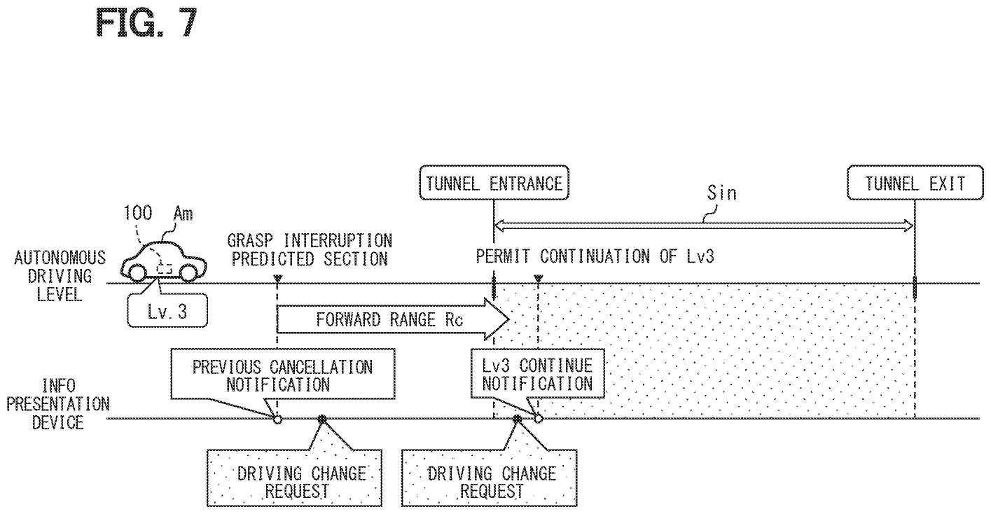

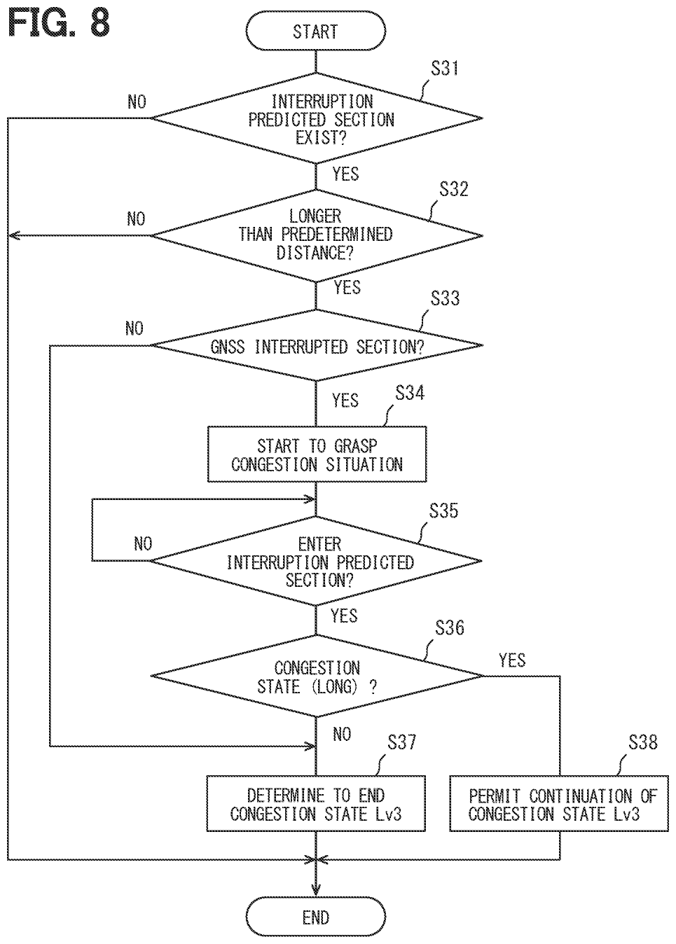

In the scene illustrated in FIG. 7, since the interruption predicted section Sin (see the dotted range) exists in the forward range Rc of the host vehicle Am, the cancellation of autonomous traveling control of the congestion state level 3 is prepared. The autonomous driving ECU 50b performs a continuation determination process (see FIG. 8) to determine whether to continue the autonomous traveling control of congestion state level 3.

In the continuation determination process, the area grasping unit 74 determines existence of interruption predicted section Sin in the forward range Rc (S31). When the interruption predicted section Sin exists in the forward range Rc (S31: YES), the area grasping unit 74 further determines whether the length of interruption predicted section Sin exceeds the predetermined distance (S32). When the interruption predicted section Sin exceeding the predetermined distance does not exist in the forward range Rc (S31: NO or S32: NO), the control switching unit 77 continues the congestion state level 3.

When the interruption predicted section Sin exceeding the predetermined distance exists in the forward range Rc (S32: YES), the area grasping unit 74 determines the type of interruption predicted section Sin (S33). Specifically, the area grasping unit 74 determines whether the interruption predicted section Sin in the forward range Rc is an interruption predicted section Sin (hereinafter, referred to as a GNSS interruption section) in which interruption of the autonomous traveling control is predicted due to a decrease in the reliability of host vehicle position information, which is caused by deterioration of the reception state of the positioning signal. When the interruption predicted section Sin existing in the forward range Rc is not the GNSS interruption section (S33: NO), the control switching unit 77 determines to end the congestion state level 3 (S37).

When the interruption predicted section Sin existing in the forward range Rc is a GNSS interruption section (S33: YES), the congestion grasping unit 75 starts to grasp a situation of traffic congestion occurring in the traveling direction of the host vehicle Am (S34). When the host vehicle Am enters the interruption predicted section Sin (S35: YES), the control switching unit 77 determines the state of congestion occurring in the interruption predicted section Sin.

The control switching unit 77 determines whether the congestion section occurred in the interruption predicted section Sin is long (S36). When the interruption predicted section Sin is congested at a predetermined ratio or higher, in other words, when the ratio of congestion section length to the interruption predicted section Sin length is equal to or higher than a predetermined threshold (for example, 80%), the control switching unit 77 determines that the congestion section is long (S36: YES). In this case, the control switching unit 77 permits continuation of the congestion state level 3 (S38). For example, when the tunnel determined as the interruption predicted section Sin is congested from the entrance to the exit, the control switching unit 77 continues the congestion state level 3 even though the host vehicle Am enters the tunnel.

When the control switching unit 77 determines that the ratio of the congestion section length to the interruption predicted section Sin length is lower than the predetermined threshold and thus the congestion section is determined to be not long (S36: NO), the control switching unit 77 determines to end the congestion state level 3 (S37). In this case, the control switching unit 77 switches the control state of the host vehicle Am to the hands-on driving assist control or to the manual driving.

When the autonomous driving ECU 50b recognizes, in the forward range Rc, an interruption predicted section Sin whose length exceeding the predetermined distance, the HCU 100 starts notification on the assumption that the congestion state level 3 is to be canceled (see FIG. 7). The information cooperation unit 82 grasps, based on the control status information, that the interruption predicted section Sin exceeding the predetermined distance has been recognized by the autonomous driving ECU 50b. The presentation control unit 88 performs a notification (hereinafter, referred to as a cancellation request notification) that notifies a previous cancellation of the congestion state level 3 in advance. The presentation control unit 88 controls the meter display 21, the HUD 23, and the like to display, for example, a message such as “Autonomous driving will end soon.” as the cancellation request notification. The presentation control unit 88 restricts playback of the video content or the like provided in relation to the second task in response to the cancellation request notification being performed.

When the interruption predicted section Sin is not a GNSS interruption section, the autonomous driving ECU 50b ends the congestion state level 3. In this case, after performing the cancellation request notification, the presentation control unit 88 performs a driving change request to the driver. Accordingly, the control right of the driving operation is transferred from the autonomous driving system 50 to the driver.

When the interruption predicted section Sin is a GNSS interruption section, the autonomous driving ECU 50b continues traveling at the congestion state level 3 until the host vehicle Am enters the GNSS interruption section. When the traffic congestion occurred in the interruption predicted section Sin (GNSS interruption section) is short, the presentation control unit 88 outputs a driving change request to the driver after the host vehicle Am enters the GNSS interruption section. When the congestion occurred in the interruption predicted section Sin (GNSS interruption section) is long, the presentation control unit 88 performs a notification indicating that the congestion state level 3 can be continued (hereinafter, referred to as a level 3 continuation notification) after the host vehicle Am enters the GNSS interruption section. The presentation control unit 88 controls the meter display 21, the HUD 23, and the like to display, for example, a message such as “Traveling by autonomous driving will be continued.” as the level 3 continuation notification. In this case, the presentation control unit 88 cancels the restriction applied to the playback of video content or the like after the level 3 continuous notification is performed.

(A scene in which reception sensitivity of positioning signal is decreased during driving by autonomous traveling control)

The following will describe a scene in which the reliability of host vehicle position information specified by the locator 35 decreases as the reception state of the positioning signal deteriorates during the autonomous driving period in which the host vehicle Am travels by the autonomous traveling control. A decrease in the reliability of host vehicle position information is assumed to occur, for example, in a tunnel, under an elevated road, in a road section located in a mountain area, in a road section surrounded by high-rise buildings, or the like. It may be assumed that the reliability of host vehicle position information is decreased due to an arrangement of the artificial satellites that transmit the positioning signals.

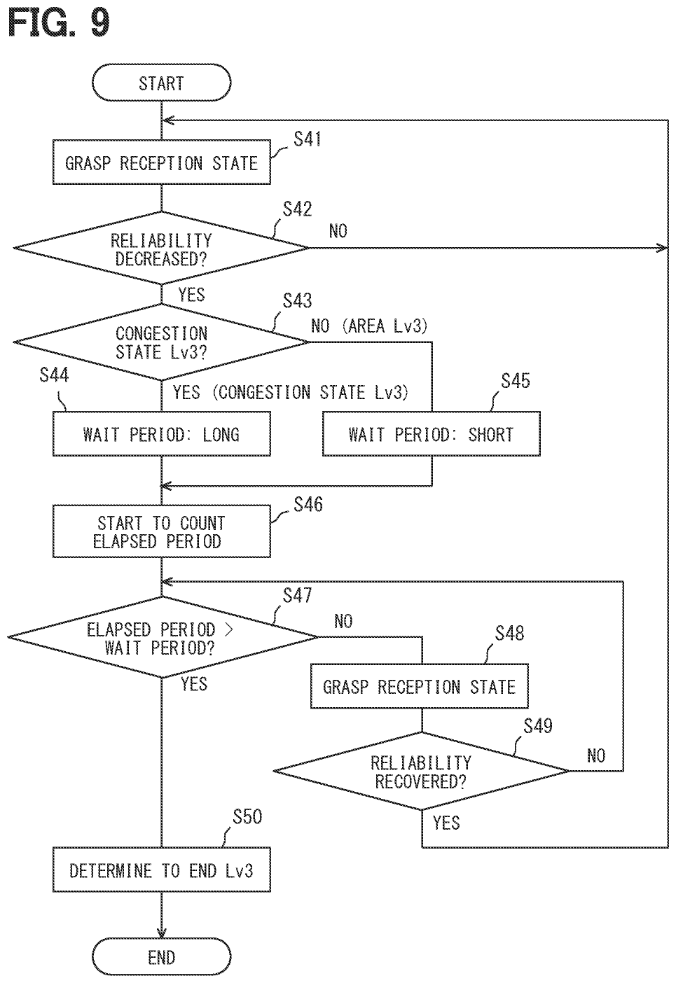

As described above, the autonomous driving ECU 50b uses the host vehicle position information, which is based on the positioning signals, in the autonomous traveling control. Therefore, the action determination unit 63 cancels the autonomous traveling control when the reception state of the positioning signal deteriorates and thus the reliability of host vehicle position information decreases during the autonomous driving period. The action determination unit 63 performs the continuation determination process (see FIG. 9) to determine whether continuation of the autonomous traveling control is possible according to the reception state of positioning signal. The action determination unit 63 starts the continuation determination process in response to a start of the autonomous traveling control, and continues the continuation determination process until the autonomous traveling control is ended.

The action determination unit 63 grasps the reception state of the positioning signal in the locator 35 through the environment recognition unit 62 (S41). The action determination unit 63 determines whether the reliability of host vehicle position information provided by the locator 35 is decreased based on the reception state of positioning signal (S42). When the reception state of positioning signal is good and the reliability of host vehicle position information is ensured (S42: NO), the action determination unit 63 continues monitoring the reception state.

When the reception state of positioning signal is deteriorated and the reliability of host vehicle position information is lower than a predetermined reference value (S42: YES), the action determination unit 63 determines that the host vehicle position is not detected. The predetermined reference value for determining the decrease in the reliability of host vehicle position information may be set to zero. That is, when all of the positioning signals are interrupted, it can be determined that the reliability of host vehicle position information is not ensured.

The action determination unit 63 determines a control mode of the autonomous traveling control being executed by the autonomous driving ECU 50b based on the decrease in the reliability of host vehicle position information (S43). The action determination unit 63 changes a determination criterion for determining whether to continue the autonomous traveling control in accordance with the control mode of autonomous traveling control executed by the autonomous driving ECU 50b. When the host vehicle Am travels at the congestion state level 3, the action determination unit 63 makes it more difficult to interrupt the autonomous traveling control due to a decrease in the reliability of host vehicle position information than when the host vehicle Am travels at the area level 3. The action determination unit 63 changes a wait period from when the reliability of host vehicle position information decreases below the predetermined reference value to when the stop of autonomous traveling control is determined according to the control mode of autonomous traveling control. The action determination unit 63 sets the wait period (S43: YES, S44) in a case where the autonomous traveling control of the congestion state level 3 is executed to be longer than a wait period (S43: NO, S45) in a case where the autonomous traveling control of the area level 3 is executed.

After setting the wait period corresponding to the control mode being executed, the action determination unit 63 starts to count an elapsed period from the decrease of reliability (S46). The action determination unit 63 determines whether the elapsed period exceeds the wait period (S47). When the elapsed period does not exceed the wait period (S47: NO), the action determination unit 63 grasps the reception state of positioning signal again (S48), and determines whether the reliability of host vehicle position information is recovered to a level exceeding the predetermined reference value (S49). When the reliability of host vehicle position information is recovered (S49: YES), the action determination unit 63 determines to continue the autonomous traveling control that is being executed, and continues monitoring the reception state of positioning signal. When the elapsed period exceeds the wait period (S47: YES) while the reliability of host vehicle position information is not recovered (S49: NO), the action determination unit 63 determines to end the autonomous traveling control that is being executed (S50). In this case, the action determination unit 63 switches the control state of the autonomous driving system 50 from the autonomous traveling control to the hands-on driving assist control or to the manual driving.

In the first embodiment described above, when the interruption predicted section Sin in which the autonomous traveling control is predicted to be interrupted exists in the traveling direction of the host vehicle Am, the level 3 possible notification, which indicates that the switch to the autonomous traveling control becomes possible, is performed as main notification. With this configuration, the switch to the autonomous traveling control is suppressed when the interruption is predicted, and a scene in which the autonomous traveling control ends within a short period is less likely to occur. Thus, it is possible to ensure the convenience of autonomous driving without periphery monitoring obligation.

In the first embodiment, when the level 3 possible notification is cancelled, the suspending reason notification is performed. Thus, the suspending reason information indicating the reason why the switch to the autonomous traveling control is suspended is notified to the driver. Therefore, it is possible to ensure that the driver is convinced that the switch to the autonomous traveling control is not permitted.

When the length of the interruption predicted section Sin existing in the forward range Rc is shorter than the predetermined distance, the decrease in the reliability of host vehicle position information can be complemented by the detection information of the periphery monitoring sensor 30 or the like. Therefore, when the interruption predicted section Sin is short, the autonomous traveling control may be continued as in the case where the interruption predicted section Sin does not exist. Such continuation of autonomous traveling control can further improve the convenience of autonomous driving.

In the first embodiment, when the length of interruption predicted section Sin is short, the level 3 possible notification is performed in accordance with the autonomous driving control as described above. Therefore, the driver can recognize that the autonomous traveling control is to be continued, and can continue to use the autonomous traveling control without anxiety. Thus, it is possible to further ensure the convenience of autonomous driving.

In the first embodiment, when the existence of interruption predicted section Sin (GNSS interruption section) is recognized, the traffic congestion situation in the interruption predicted section Sin is further recognized. The interruption predicted section is a section where the interruption of autonomous traveling control due to a decrease in the reliability of host vehicle position information is predicted. When the traffic congestion in the interruption predicted section Sin is recognized, continuation of the autonomous traveling control is permitted even though the reliability of host vehicle position information is decreased. As described above, when traveling in a traffic congestion, the traveling speed of host vehicle Am decreases, and information on other vehicles existing around the host vehicle can be used. Therefore, the autonomous traveling control can be continued without depending on the host vehicle position information. Therefore, even in a case where the reliability of host vehicle position information decreases, by permitting continuation of autonomous traveling control on the condition that the host vehicle travels in a traffic congestion, it is possible to ensure the convenience of autonomous driving without periphery monitoring obligation.

In the first embodiment, when the host vehicle Am travels at the congestion state level 3, the interruption of autonomous traveling control due to the decrease in the reliability of host vehicle position information, which is caused by the deterioration in reception state of positioning signal, is less likely to occur than when the host vehicle Am travels at the area level 3. As described above, when the host vehicle travels in a traffic congestion, the autonomous traveling control can be continued without depending on the host vehicle position information. Therefore, even in a case where the reliability of host vehicle position information decreases, by continuing the traveling at the congestion state level 3, it is possible to ensure the convenience of autonomous driving without periphery monitoring obligation.

In the above embodiment, the environment recognition unit 62 corresponds to a “position information acquiring unit”, the action determination unit 63 corresponds to a “traveling control unit”, the area grasping unit 74 corresponds to a “section grasping unit”, the information cooperation unit 82 corresponds to a “control grasping unit”, and the presentation control unit 88 corresponds to a “notification control unit”. Further, the forward range Rc corresponds to a “predetermined range”, the AD area corresponds to a “specific area”, the autonomous driving ECU 50b corresponds to an “autonomous driving control device”, and the HCU 100 corresponds to a “presentation control device”.

### Second Embodiment

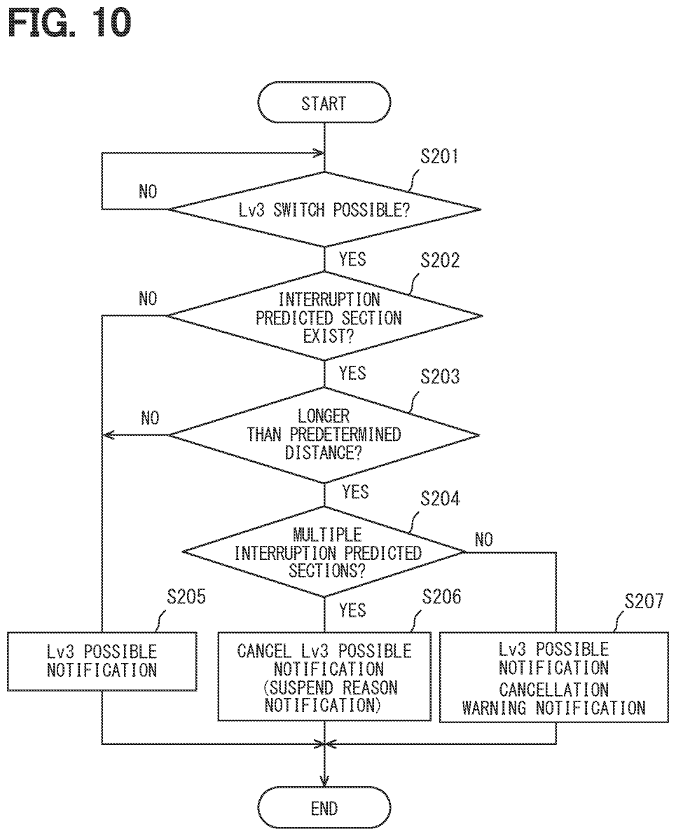

The second embodiment of the present disclosure is a modification of the first embodiment. In the second embodiment, details of a notification control process (see FIG. 10) performed by the HCU 100 are different from the notification control process (see FIG. 5) of the first embodiment. Hereinafter, details of the notification control process according to the second embodiment will be described based on FIG. 10 with reference to FIG. 1 to FIG. 4.

The HCU 100 grasps whether the control switch from the driving assist control to the autonomous traveling control becomes possible by the information cooperation unit 82 (S201). When the information cooperation unit 82 grasps that the control switch to the autonomous traveling control becomes possible (S201: YES), the information cooperation unit 82 further grasps whether the interruption predicted section Sin exists in the forward range Rc (S202). When the interruption predicted section Sin exists in the forward range Rc (S202: YES), the information cooperation unit 82 determines whether the length of interruption predicted section Sin exceeds the predetermined distance (S203). When the interruption predicted section Sin does not exist in the forward range Rc (S202: NO), or when the length of interruption predicted section Sin is equal to or shorter than the predetermined distance (S203: NO), the presentation control unit 88 performs the level 3 possible notification (S205).

When the existence of interruption predicted section Sin having a length exceeding the predetermined distance is recognized (S203: YES), the information cooperation unit 82 determines whether multiple interruption predicted sections Sin exist (S204). In this case, the range within which the existence of multiple interruption predicted sections Sin is determined may be extended in the traveling direction from the forward range Rc in which the existence of the closest interruption predicted section Sin is determined. When multiple interruption predicted sections Sin exist in the traveling direction of the host vehicle Am and a length of each interruption predicted section exceeds the predetermined distance (S204: YES), the presentation control unit 88 cancels the level 3 possible notification (S206). In this case, the presentation control unit 88 performs the suspending reason notification in the same manner as in the first embodiment. Note that the suspending reason notification may be omitted after passing through the closest interruption predicted section Sin.

In a case where the vehicle is not predicted to pass through multiple interruption predicted sections Sin and only one interruption predicted section exists and has the length exceeding the predetermined distance (S204: NO), the presentation control unit 88 performs the level 3 possible notification (S207). In this case, the presentation control unit 88 performs, together with the level 3 possible notification, notification of cancellation warning information (cancellation warning notification) for warning of early cancellation of autonomous traveling control. The presentation control unit 88 controls at least the cancellation warning information to be displayed on the same display device as the switch possible information. Specifically, the presentation control unit 88 may control the meter display 21, the HUD 23, and the like to display a message such as “Second task becomes available.”, which corresponds to the switch possible information. The presentation control unit 88 may control the meter display 21, the HUD 23, and the like to display a message such as “There is a tunnel ahead. Autonomous driving cannot be used soon.” as the cancellation warning information together with the message of switch possible information.

In the second embodiment described above, the same effects as those of the first embodiment can be obtained, and the convenience of the autonomous driving without periphery monitoring obligation can be secured. In the second embodiment, when the interruption predicted section Sin, in which the interruption of autonomous traveling control is predicted in the traveling direction of the host vehicle Am, exists, the cancellation warning information for warning the early cancellation of autonomous traveling control is notified together with the switch possible information by the cancellation warning notification and the level 3 possible notification. Accordingly, when the interruption is predicted, the switch to the autonomous traveling control can be suppressed, and thus a scene in which the autonomous traveling control ends in a short time is less likely to occur. Thus, it is possible to ensure the convenience of autonomous driving without periphery monitoring obligation.

In the second embodiment, when there are multiple interruption predicted sections Sin in the traveling direction of the host vehicle Am, the level 3 possible notification is canceled. Therefore, it is possible to avoid that the level 3 possible notification and the cancellation warning notification are performed every time the vehicle passes through the interruption predicted section Sin when the vehicle continuously passes through multiple interruption predicted sections Sin. Thus, the driver is less likely to feel annoyed by the repeated notification. As a result, the convenience of autonomous driving without periphery monitoring obligation can be further ensured.

### Other Embodiments

Although multiple embodiments of the present disclosure have been described above, the present disclosure should not be construed as being limited to the above-described embodiments, and can be applied to various embodiments and combinations without departing from the spirit of the present disclosure.

In a first modification of the second embodiment, even when multiple interruption predicted sections Sin each having a length exceeding the predetermined distance exist in the forward range in the traveling direction of the host vehicle Am, the level 3 possible notification and the cancellation warning notification may be performed.

In a second modification of the above embodiments, the suspending reason notification may be not performed even when the level 3 possible notification is canceled due to the existence of interruption predicted section Sin. Thus, the suspending reason information may not be notified to the driver. Whether to perform the suspending reason notification may be configured to be set by the driver. In a third modification of the above embodiments, the determination of length of the interruption predicted section Sin (GNSS interruption section) may be omitted. In the third modification, when the interruption predicted section Sin exists in the forward range Rc, even if the interruption predicted section Sin is short, the level 3 possible notification is canceled or the cancellation warning notification is performed.

In the above embodiments, the predetermined distance (see S23 in FIG. 5) for determining whether switch to the autonomous traveling control becomes possible is set to be substantially the same as the predetermined distance (see S32 in FIG. 8) for determining whether to continue the autonomous traveling control. In a fourth modification and a fifth modification of the above embodiments, the predetermined distances may be set to be different from one another. In the fourth modification, the predetermined distance in the case of determining whether switch to the autonomous traveling control becomes possible is set to be shorter than the predetermined distance in the case of determining whether to continue the autonomous traveling control. In the fifth modification, the predetermined distance in the case of determining whether switch to the autonomous traveling control becomes possible is set to be longer than the predetermined distance in the case of determining whether to continue the autonomous traveling control.

In the above embodiments, the distance in the traveling direction of host vehicle set as the forward range Rc for determining whether switch to the autonomous traveling control becomes possible is set to be substantially same as the distance in the traveling direction of the host vehicle set as the forward range Rc for determining whether to continue the autonomous traveling control. In a sixth modification and a seventh modification of the above embodiments, the distances defined as the forward ranges Rc may be set to be different from one another. In the sixth modification, the forward range Rc in the case of determining whether switch to the autonomous traveling control becomes possible may be set to be longer (farther) than the forward range Rc in the case of determining whether to continue the autonomous traveling control. In the seventh modification, the forward range Rc in the case of determining whether switch to the autonomous traveling control becomes possible may be set to be shorter (closer) than the forward range Rc in the case of determining whether to continue the autonomous traveling control.

In an eighth modification of the above embodiments, even in a scene where the autonomous traveling control can be continued by complementation with the detection information of periphery monitoring sensor 30, the autonomous traveling control may be ended in response to the reliability of host vehicle position information being decreased.

In a ninth modification of the above embodiments, the wait period when the end of autonomous traveling control is determined in response to a decrease in the reliability of host vehicle position information may be set to a substantially constant period regardless of the control mode of the autonomous traveling control.

In a tenth modification of the above embodiment, the interruption of autonomous traveling control due to the decrease in reliability of host vehicle position information is less likely to occur in the case of executing the congestion state level 3 than in the case of executing the area level 3 by a different process from the above-described process of setting the respective wait periods to have different values. In the tenth modification, the reference value for determining that the reliability has decreased is set to be lower in the case of executing the congestion state level 3 than in the case of executing the area level 3. That is, during the execution of the congestion state level 3, it is less likely to be determine that the reliability of host vehicle position information has decreased than during the execution of area level 3.

In an eleventh modification of the above embodiment, the functions of driving assist ECU 50a and the autonomous driving ECU 50b may be provided by a single autonomous driving ECU. That is, the functions of driving assist ECU 50a may be implemented in the autonomous driving ECU 50b in the eleventh modification. In the eleventh modification, the integrated autonomous driving ECU corresponds to an “autonomous driving control device”. The functions of the HCU 100 may also be implemented in the integrated autonomous driving ECU. In this configuration, the autonomous driving ECU also corresponds to a “presentation control device”.

In the above embodiments, the functions provided by the driving assist ECU, autonomous driving ECU, and the HCU can be provided by (i) combination of software and hardware that executes the software, (ii) only the software, (iii) only the hardware, or (iv) a complex combination of (i) through (iii). Further, when such functions are provided by an electronic circuit as hardware, each function can also be provided by a digital circuit including a large number of logic circuits or an analog circuit.

Each processor described in the above embodiments may be hardware for arithmetic processing combined with a RAM. The processor includes at least one arithmetic core such as a central processor (CPU) and a graphics processor (GPU). The processor may further include a field-programmable gate array (FPGA), a neural network processor (NPU), an IP core having other dedicated functions, and the like. Such a processor may be configured to be individually mounted on a printed circuit board, or may be configured to be mounted on an application specific integrated circuit (ASIC), an FPGA, or the like.

In addition, the form of a storage medium (a non-transitory tangible computer readable medium) that stores various programs and the like may also be appropriately changed. The storage medium is not limited to the configuration provided on the circuit board, and may be provided in the form of a memory card or the like, inserted into a slot portion, and electrically connected to a control circuit such as an autonomous driving ECU or an HCU. The storage medium may include an optical disk which forms a source of programs to be copied into the autonomous driving ECU or the HCU, or a hard disk drive therefor.

The vehicle on which the autonomous driving system and the HMI system are mounted is not limited to a general private passenger car, and may be a vehicle, such as a rental car, a manned taxi, a shared car, a cargo truck, a bus, or the like. The vehicle equipped with the autonomous driving system and the HMI system may be a right-hand drive vehicle or a left-hand drive vehicle. Further, the traffic environment in which the vehicle travels may be a traffic environment premised on left-hand traffic or a traffic environment premised on right-hand traffic. The information presentation control and the autonomous driving control according to the present disclosure may be appropriately optimized according to the road traffic law of each country and region, the steering wheel position of the vehicle, and the like.

The control unit and the method thereof described in the present disclosure may be implemented by a special purpose computer, which includes a processor programmed to execute one or more functions performed by computer programs. Alternatively, the device and the method thereof described in the present disclosure may also be implemented by a dedicated hardware logic circuit. Alternatively, the device and the method thereof described in the present disclosure may be implemented by one or more dedicated computers configured by a combination of a processor that executes a computer program and one or more hardware logic circuits. The computer program may be stored in a computer-readable non-transitory tangible recording medium as instructions to be executed by a computer.

What is claimed is:

1. A presentation control device used in a vehicle capable of traveling with autonomous driving function, the presentation control device controlling presentation of information relating to the autonomous driving function, the presentation control device comprising:
a control grasping unit grasping whether a switch from a driving assist control, which requires a periphery monitoring by a driver as an obligation, to an autonomous traveling control, which does not require the periphery monitoring by the driver as the obligation, becomes possible; and
a notification control unit notifying switch possible information indicating that the switch to the autonomous traveling control becomes possible,
wherein
the notification control unit cancels a notification of the switch possible information when an interruption predicted section exists in a predetermined range defined in a traveling direction of the vehicle from a position where the switch to the autonomous traveling control becomes possible, and
the interruption predicted section is a section in which an interruption of the autonomous traveling control is predicted.

2. A presentation control device used in a vehicle capable of traveling with autonomous driving function, the presentation control device controlling presentation of information relating to the autonomous driving function, the presentation control device comprising:
a control grasping unit grasping whether a switch from a driving assist control, which requires a periphery monitoring by a driver as an obligation, to an autonomous traveling control, which does not require the periphery monitoring by the driver as the obligation, becomes possible; and
a notification control unit notifying switch possible information indicating that the switch to the autonomous traveling control becomes possible,
wherein
the notification control unit notifies cancellation warning information, which indicates a warning of early cancellation of the autonomous traveling control, together with the switch possible information when an interruption predicted section exists in a predetermined range defined in a traveling direction of the vehicle from a position where the switch to the autonomous traveling control becomes possible, and
the interruption predicted section is a section in which an interruption of the autonomous traveling control is predicted.

3. The presentation control device according to claim 2, wherein
the notification control unit cancels a notification of the switch possible information when a plurality of the interruption predicted sections exist.

4. The presentation control device according to claim 3, wherein,
in a case where the notification control unit cancels the notification of the switch possible information, the notification control unit notifies a suspending reason information indicating a reason of suspending the switch to the autonomous traveling control.

5. The presentation control device according to claim 2, wherein
the notification control unit notifies the switch possible information when a length of the interruption predicted section existing in the predetermined range is shorter than a predetermined distance.

6. A computer-readable non-transitory storage medium storing a presentation control program, the presentation control program being used in a vehicle capable of traveling with autonomous driving function and controlling presentation of information relating to the autonomous driving function, the presentation control program comprising instructions to be executed by at least one processor and the instructions comprising:
grasping whether a switch from a driving assist control, which requires a periphery monitoring by a driver as an obligation, to an autonomous traveling control, which does not require the periphery monitoring by the driver as the obligation, becomes possible;
notifying switch possible information when an interruption predicted section does not exist in a predetermined range defined in a traveling direction of the vehicle from a position where the switch to the autonomous traveling control becomes possible, the interruption predicted section being a section in which an interruption of the autonomous traveling control is predicted; and
cancelling a notification of the switch possible information when the interruption predicted section exists in the predetermined range.

7. A computer-readable non-transitory storage medium storing a presentation control program, the presentation control program being used in a vehicle capable of traveling with autonomous driving function and controlling presentation of information relating to the autonomous driving function, the presentation control program comprising instructions to be executed by at least one processor and the instructions comprising:
grasping whether a switch from a driving assist control, which requires a periphery monitoring by a driver as an obligation, to an autonomous traveling control, which does not require the periphery monitoring by the driver as the obligation, becomes possible;
notifying switch possible information when an interruption predicted section does not exist in a predetermined range defined in a traveling direction of the vehicle from a position where the switch to the autonomous traveling control becomes possible, the interruption predicted section being a section in which an interruption of the autonomous traveling control is predicted; and
notifying cancellation warning information, which indicates a warning of early cancellation of the autonomous traveling control, together with the switch possible information when the interruption predicted section exists in the predetermined range.

8. An autonomous driving control device that enables a vehicle to travel by an autonomous driving function, the autonomous driving control device comprising:
a traveling control unit executing an autonomous traveling control, which does not require a periphery monitoring by a driver as an obligation, to the vehicle using position information of the vehicle, the position information of the vehicle being specified based on positioning signals transmitted from multiple positioning satellites;
a section grasping unit grasping existence of an interruption predicted section in which an interruption of the autonomous traveling control is predicted due to a decrease in reliability of the position information of the vehicle associated with a deteriorated reception state of the positioning signals; and
a congestion grasping unit grasping a situation of traffic congestion being occurred in a traveling direction of the vehicle,
wherein, when the interruption predicted section has a traffic congestion, the traveling control unit permits continuation of the autonomous traveling control even though the reliability of the position information of the vehicle decreases.

9. A computer-readable non-transitory storage medium storing an autonomous driving control program, the autonomous driving control program enabling a vehicle to travel by an autonomous driving function and comprising instructions to be executed by at least one processor, the instructions comprising:
executing an autonomous traveling control, which does not require a periphery monitoring by a driver as an obligation, to the vehicle using position information of the vehicle, the position information of the vehicle being specified based on positioning signals transmitted from multiple positioning satellites;
grasping existence of an interruption predicted section in which an interruption of the autonomous traveling control is predicted due to a decrease in reliability of the position information of the vehicle associated with a deteriorated reception state of the positioning signals;
grasping a situation of traffic congestion being occurred in a traveling direction of the vehicle; and
when the interruption predicted section has a traffic congestion, permitting continuation of the autonomous traveling control even though the reliability of the position information of the vehicle decreases.

10. An autonomous driving control device that enables a vehicle to travel by an autonomous driving function, the autonomous driving control device comprising:
a position information acquiring unit acquiring position information of the vehicle based on positioning signals transmitted from multiple positioning satellites; and
a traveling control unit executing an autonomous traveling control, which does not require a periphery monitoring by a driver as an obligation, to the vehicle using the position information of the vehicle;
wherein
the traveling control unit switches a control mode of the autonomous traveling control within multiple control modes,
the multiple control modes at least include a congestion limited control, which permits the autonomous traveling control only in a traffic congestion, and an area limited control, which permits the autonomous traveling control only in a specific area, and
when the vehicle travels under the congestion limited control, the traveling control unit sets the autonomous traveling control to be less likely interrupted due to a decrease in reliability of the position information of the vehicle associated with a deteriorated reception state of the positioning signals, compared with when the vehicle travels under the area limited control.

11. A computer-readable non-transitory storage medium storing an autonomous driving control program, the autonomous driving control program enabling a vehicle to travel by an autonomous driving function and comprising instructions to be executed by at least one processor, the instructions comprising:
executing an autonomous traveling control, which does not require a periphery monitoring by a driver as an obligation, to the vehicle using position information of the vehicle, the position information of the vehicle being specified based on positioning signals transmitted from multiple positioning satellites;
switching a control mode of the autonomous traveling control within multiple control modes, the multiple control modes at least including a congestion limited control, which permits the autonomous traveling control only in a traffic congestion, and an area limited control, which permits the autonomous traveling control only in a specific area; and
when the vehicle travels under the congestion limited control, setting the autonomous traveling control to be less likely interrupted due to a decrease in reliability of the position information of the vehicle associated with a deteriorated reception state of the positioning signals, compared with when the vehicle travels under the area limited control.

12. The presentation control device according to claim 1, wherein,
in a case where the notification control unit cancels the notification of the switch possible information, the notification control unit notifies a suspending reason information indicating a reason of suspending the switch to the autonomous traveling control.

13. The presentation control device according to claim 1, wherein
the notification control unit notifies the switch possible information when a length of the interruption predicted section existing in the predetermined range is shorter than a predetermined distance.
